(19) United States
(12) Patent Application Publication
(10) Pub. No.: US 2017/0320393 A1
(43) Pub. Date: Nov. 9, 2017

(54) HYDROGEN RECUPERATION FOR VEHICLES

(71) Applicant: Robert Bosch GmbH, Stuttgart (DE)

(72) Inventors: Guenter Reitemann, Schwieberdingen (DE); Gerhard Walter, Gerlingen (DE)

(21) Appl. No.: 15/526,797

(22) PCT Filed: Sep. 23, 2015
(86) PCT No.: PCT/EP2015/071837

§ 371 Date: May 15, 2017

(30) Foreign Application Priority Data
Nov. 18, 2014 (DE) 102014223530.8

(51) Int. Cl. B60L 7/16; H01M 16/00; B60L 11/18; H01M 8/18; H01M 8/0656

(52) U.S. Cl. CPC B60L 7/16; H01M 8/186; H01M 8/0656; B60L 11/1898; H01M 16/003; B60Y 2400/202; H01M 2250/20; H01M 2250/402

(57) ABSTRACT

The invention relates to a method (100) for converting and/or storing electric energy E obtained from mechanical energy M in a vehicle comprising a motor (1), in particular a motor vehicle. In the method, a) mechanical energy M obtained when braking and/or during an overrun operation of the vehicle is converted into electric energy E in a first step using a generator (2), b) the electric energy is stored in an intermediate energy store (3) in a second step, c) the stored electric energy E is discharged to an electrolysis module (4) in a third step, d) the module converts the electric energy E into chemical energy C in a fourth step at least by splitting water (H₂O) into hydrogen (H₂) and oxygen (O2), and e) the chemical energy is conducted into a gas tank (5) of the vehicle for temporary storage and/or is supplied to the motor (1) and/or a fuel cell (10) of the vehicle in a fifth step.

The present invention relates to a method for converting and/or storing electric energy E obtained from mechanical energy M in a vehicle comprising a motor according to claim 1 as well as to a mobile system for converting mechanical energy M via electric energy into chemical energy C according to claim 9.

### TECHNICAL FIELD

In present day vehicles—for example in passenger vehicles or commercial vehicles—it is known how to recover braking energy in the form of electric energy. This method is known as recuperation. In so doing, a battery is generally used as the energy storage unit. In addition, approaches for the energy storage are known in which a hydraulic system or compressed air system are used. Accordingly, two different energy storage forms for vehicles are known, namely in one case a chemical storage unit in the form of a fuel tank, i.e. a fuel or gas tank usually installed in the vehicle and depending on the embodiment additionally an electric storage unit in the form of a battery or a pressure reservoir. When recovering the braking energy in the form of electric energy, which is intermediately stored in a battery, it is a disadvantage that high mechanical output, which temporarily accumulates and is converted into electric energy, has to be accommodated by the battery. That means that the battery or in general terms the storage unit must have a high power density. Apart from that, the power output is, for example, not so high during extended descents, which is why the storage unit has to accommodate more energy, i.e. said storage unit has to have a high energy density. In addition, a high cycle stability of the storage unit is required so that said storage unit does not lose too much capacity during the operation of the vehicle over an extended operating life. A simultaneous optimization of the power density and the energy density of a storage unit is however currently not possible. Therefore, a compromise has to currently always be made so that the storage unit has either a high power density or else a high energy density. The currently known high performance electric storage units, which have a high cycle stability, relate preferably to lithium-ion storage batteries, the costs of which are very high.

### SUMMARY

It is the aim of the invention to overcome at least one of the disadvantages described above when storing energy obtained from the braking energy. It is particularly the aim of the invention to provide a method for storing the mechanical power converted into electric energy during deceleration by means of recuperation as well as to provide a mobile system for converting mechanical energy, which provides a separation of power and energy storage and facilitates the recovery of the braking energy and the storage thereof in a cost-effective manner. A further aim of the present invention is optionally to reduce the CO₂ emissions and the primary fuel consumption while simultaneously minimizing the system costs.

The aim mentioned above is met by a method for converting and/or storing electric energy E obtained from mechanical energy M in a vehicle comprising a motor, said method having the features of the independent claim 1 as well as by a mobile system for converting mechanical energy M via electric energy E into chemical energy C, said mobile system having the features of the independent claim 9. Further features and details of the invention ensue from the dependent claims, the description and the drawings. In this regard, features and details, which are described in connection with the method according to the invention, apply, of course, in connection with the mobile system according to the invention and in each case vice versa. Thus, reference always is/can be made reciprocally to the individual aspects of the invention with regard to the disclosure.

In a first aspect of the invention, a method for converting and/or storing electric energy E obtained from mechanical energy M in a vehicle comprising a motor, in particular a motor vehicle, wherein mechanical energy M obtained when braking and/or during an overrun operation of the vehicle is converted into chemical energy C, has the following procedural steps:

a) in a first step, the mechanical energy M is converted into electric energy E using a generator.

In a subsequent second step

b) the electric energy E is stored in an intermediate energy store and in a third step the stored electric energy E
c) is discharged to an electrolysis module which in a fourth step
d) converts electric energy E into chemical energy C at least by splitting water into hydrogen and oxygen, and said chemical energy C
e) is conducted into a gas tank of the vehicle for temporary storage and/or is supplied to the motor and/or a fuel cell of the vehicle.

According to the invention, the capacity of a typical power storage can be reduced by said power storage temporarily storing the energy converted from mechanical energy M into electric energy E when braking and/or during an overrun operation as an intermediate energy store, which preferably does not transmit electric energy E to an electric motor or to the vehicle electrical system. According to the invention, the electric energy is in fact used in an electrolysis module to convert water to hydrogen and oxygen, i.e. into chemical energy C and to store the same in a chemical energy store. By virtue of the fact that the electric energy E converted into chemical energy C is provided to a motor, for example an internal combustion engine, preferably a spark ignition engine, or else a fuel cell of the vehicle as combustible gas (e.g. in the form of hydrogen, methane or oxygen), energy required from the outside can be significantly saved or respectively reduced. In the case of the internal combustion engine, which in the scope of the invention is only in general denoted as “motor”, the combustible gas is converted by means of combustion directly into mechanical energy. The combination of fuel cell with at least one downstream electric motor or generator is considered within the scope of the invention to be denoted likewise in general as “motor”, wherein the combustible gas is initially converted into electric energy by means of at least one fuel cell and said electric energy is converted by at least one electric motor or generator into mechanical energy.

In the case of a vehicle operated with a fuel cell, the chemical energy C obtained from the electric energy E, i.e. the products from the electrolysis of water, can be supplied to a fuel cell using the energy E obtained from the mechanical energy M, said fuel cell, for example, converting the hydrogen obtained during the electrolysis of water and comprising oxygen, which either comes from the electrolysis or from the ambient air, to water while obtaining electric energy D. In this respect, the advantage arises with the method according to the invention and the mobile system according to the invention that no additional energy storage unit, for example in the form of a traction battery, is necessary, which would take up much installation space and add additional weight in the vehicle. Moreover, the CO₂ emissions can be reduced by reducing the propellant or respectively fuel as a result of burning the chemical energy C, for example in the form of hydrogen, obtained during the electrolysis from the electric energy E and subsequently supplied to the motor. In addition, the costs for a high-performance electric storage unit, e.g. for a lithium-ion storage battery, can be avoided because the electric energy E is converted in accordance with the invention into chemical energy, for example into hydrogen in the gas form, wherein said hydrogen can be temporarily stored in a gas tank, preferably in a gas tank that is already present in the vehicle, whereby the system costs can be minimized. In addition, the chemical energy density and therefore the space requirements of a storage unit for chemical energy are substantially more optimal with respect to an electric storage unit having a high energy density. The power storage unit can also be reduced to a significantly smaller dimensioned short-term intermediate store (e.g. a double layer capacitor), which is smaller and more advantageous than a typical traction battery.

The method for converting mechanical energy M into chemical energy C and the inventive mobile system for converting mechanical energy M via electric energy E into chemical energy can particularly advantageously be used in a gas operated vehicle, which, for example is operated with liquefied petroleum gas or natural gas. The advantages, which are thereby provided, are obvious because the gas operated vehicles already have a gas tank which can store chemical energy C which is converted from electrical energy via the electrolysis. Thus, the mechanical energy M arising when braking or during an overrun-operation of the vehicle can be temporarily stored using a generator, for example in a super cap capacitor that is used as an intermediate throughput store, and then is temporarily stored in the form of chemical energy C, which is converted from the electric energy E by means of the electrolysis using the electric energy E, in the gas tank for further combustion by means of the motor.

In an advantageous manner, a higher system voltage (from the mobile system) and/or the vehicle power supply voltage can also be applied in order to increase the power density of the intermediate energy store. The higher system voltage is increased with respect to the usual vehicle electrical system voltage from 12 volts for passenger vehicles to at least 24 volts or 48 volts and with respect to the usual vehicle electrical system voltage of 24 volts for trucks to at least 48 volts. A system voltage (from the mobile system) and/or the vehicle electrical system voltage in the vehicle can also be applied greater than 48 V, in order to further optimize the power density of the intermediated energy store in an advantageous manner.

In an advantageous manner, the hydrogen and oxygen can be produced with the aid of the electric energy from the power store via the electrolysis in the electrolysis module, wherein the hydrogen is advantageously pumped into a gas tank or respectively fuel tank or into the already present gas tank in a compressed form in the case of gas operated vehicles or is optionally directly supplied to the motor or the fuel cell of the vehicle. In a preferred manner, a compressor is suitable for compressing the hydrogen or respectively oxygen or, as the case may be, the carbon monoxide or carbon dioxide converted in a reactor module to methane (which is subsequently described in detail). In order not to lose the energy recovered by recuperation for driving the compressor, said compressor can preferably be driven via the exhaust gases of the engine, for example in the form of a turbocharger. Of course, the electric energy E converted from the mechanical energy M can, however, also partially be used to electrically drive the compressor.

In the case of the method according to the invention and the mobile system, it is basically advantageous that fuel to be tanked (to be bought, to be supplied from outside), for example the liquefied petroleum gas or the natural gas, can be reduced by the hydrogen content or respectively by the oxygen content, which can be supplied to the internal combustion engine as combustion gas, wherein the CO₂ emissions of the engine cam be reduced in total by reducing the fuel.

In an advantageous manner, the water required for the electrolysis comes from an auxiliary water tank and/or can be provided from the exhaust gas of the engine via an exhaust gas treatment system or as a product of the reaction of hydrogen with oxygen from the fuel cell.

The energy C converted in form of hydrogen and oxygen by means of the electrolysis can be, as previously described, also be supplied to a fuel cell, which, by means of the reaction of hydrogen with oxygen to water, provides the electric energy D obtained thereby to, for example, the on-board power supply of the vehicle.

As previously described, the method can be advantageously modified to the extent that the hydrogen obtained during the electrolysis reacts with the carbon monoxide or carbon dioxide discharged in the exhaust gases of the internal combustion engine in a reactor module to produce methane, which is fed into the gas tank and provided to the engine from there, whereby the carbon monoxide and/or carbon dioxide balance of the engine can be further improved.

The carbon monoxide or carbon dioxide discharged from the exhaust of gases the internal combustion engine can however alternatively or in a complementary manner can be supplied for introduction into the internal combustion engine or as an anode gas of a fuel cell, for example a molten carbonate or solid oxide fuel cell.

In a second aspect of the invention, the aim is met by means of a mobile system for converting mechanical energy M via electric energy into chemical energy C. The mobile system converts the electric energy E obtained from mechanical energy M into chemical energy C while carrying out the method according to the invention and is connected to a motor system of a vehicle, in particular a motor vehicle, comprising a water tank, an electrolysis module that is at least connected to the water tank and is supplied with electric energy from an intermediate energy store of the motor system and a compressor that is connected at least to a gas tank of the motor system in order to compress at least the hydrogen converted in the electrolysis module from the water prior to being introduced into the gas tank.

The mobile system is particularly connected to the motor system and/or to the fuel cell system of the vehicle fluidically, electronically, mechanically and/or by means of control technology.

In order to avoid being repetitious with regard to the advantages of the inventive mobile system for converting mechanical energy M via electric energy E into chemical energy C, reference is made to the embodiments pursuant to the method according to the invention. All of the advantages, which have been described with regard to the method according to the first aspect, thus apply, of course, also to the mobile system according to the invention.

### BRIEF DESCRIPTION OF THE DRAWINGS

The method according to the invention and the modifications thereto as well as the advantages thereof and the mobile system according to the invention, which works with the method according to the invention, and the modifications thereto as well as the advantages thereof are subsequently explained in detail with the aid of the drawing.

It goes without saying that the previously mentioned features, which are to be explained in greater detail below, can be used not only in the combination specified in each case but also in other combinations.

In the drawing:

FIG. 1 shows a block diagram of the method according to the invention.

### DETAILED DESCRIPTION

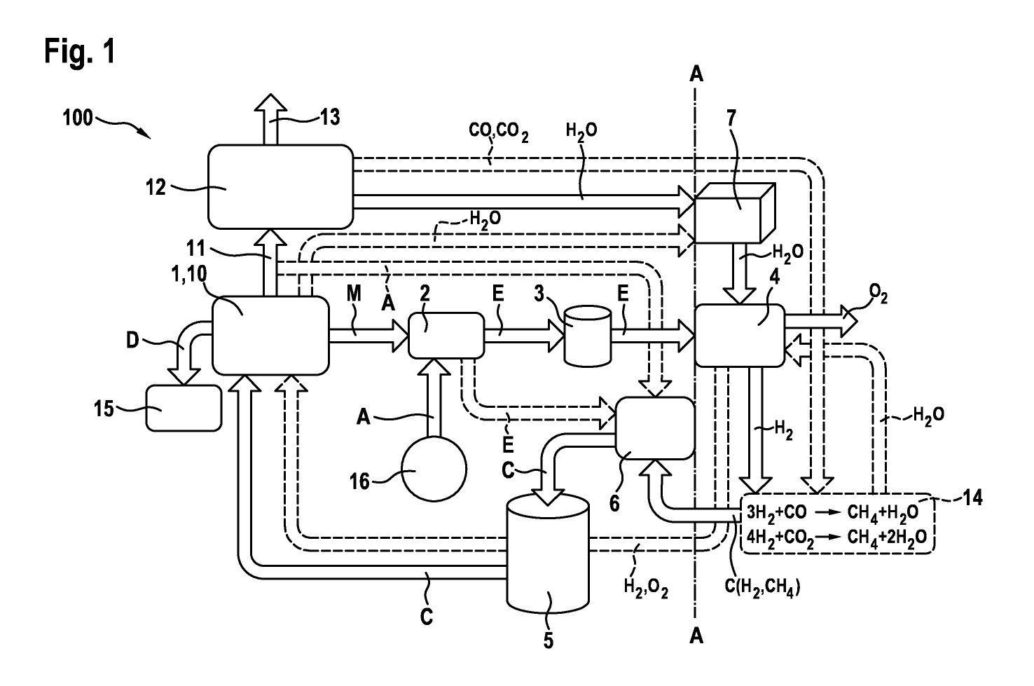

FIG. 1 shows schematically a method 100 according to the invention for operating a mobile system, i.e. a mobile recuperation system which operates in a mobile motor system and/or a mobile fuel cell system. The essential elements of the motor or fuel cell system lie in the depiction of FIG. 1 to the left of the line A-A. The elements which allow for the connection to the elements of the motor or respectively fuel cell system lie in the depiction of FIG. 1 to the right of the line A-A. The arrows comprising the dashed lines, respectively the reactor module 14 depicted with the dashed lines, represent optional connections, respectively an optional module or can be used as alternatives to the elements and connections depicted with the solid lines.

The method 100 depicted in FIG. 1 is used for converting and/or storing of electric energy E obtained from mechanical energy M in a vehicle, i.e. in a mobile system comprising a motor 1 and/or a fuel cell 10. In the method 100, energy M obtained when braking and/or during an overrun operation of the vehicle is converted into electric energy E in first step a) using a generator 2. In so doing, the mechanical energy M either from the motor 1, for example via the alternator operating as a generator or else during a braking operation via a wheel 16 of the vehicle and a generator 2 connected to the wheel, for example a motor, is converted into electric energy E by means of recuperation. The electric energy E is stored in an intermediate energy store (3) in a second step b) or optionally supplied to a compressor 6. In so doing, the generator 2 and the intermediate energy store 3 can, of course, also be connected to the on-board power supply 15 of the vehicle or else to other electric consumers of the vehicle. In a third step c), the electric energy B converted from the mechanical energy M via the generator 2, i.e. the recuperation energy is discharged to an electrolysis module 4. The electrolysis module 4 is used to convert water (H₂O) into hydrogen (H₂) and oxygen (O₂) using electric energy E. The chemical energy obtained by splitting water into hydrogen and oxygen is supplied to the compressor 6 in the form of hydrogen, which compresses the hydrogen in an optional fifth step e) and pumps said hydrogen into a gas tank 5 of the vehicle for temporary storage.

Alternatively, the chemical energy C obtained in the form of hydrogen and oxygen can be directly supplied to the motor 1, for example an internal combustion engine or the fuel cell 10 of the vehicle as combustion gas. The hydrogen content or respectively oxygen content supplied to the motor 1 thereby reduces the consumption, i.e. the amount of the fuel to be burned, and thus the CO₂ emissions of the motor 1, which is for example configured as an internal combustion engine. The chemical energy C coming from the electrolysis can, however, also be supplied to the fuel cell 10, which converts the chemical energy C into electric energy D by the hydrogen reacting with oxygen to form water. The electric energy D can, then, for example, be supplied to the on-board power supply 15 of the vehicle.

The water required for the electrolysis can come from a water tank 7 or can alternatively come via an exhaust gas treatment system 12 from the exhaust gases 11 of the motor 1 or from the reaction of the hydrogen with the oxygen to form water from the fuel cell 10. In order, however, to be able to always sufficiently provide water to the electrolysis module 4, it is advantageous to dispose the water tank as an intermediate store between the exhaust gas treatment system 12 and/or the fuel cell 10 and the electrolysis module 4. On the other hand, the water store 7 can be eliminated if it can be ensured that water is always sufficiently provided from the exhaust gas treatment system 12, i.e. from the exhaust gases 11 of the motor 1 or the fuel cell 10, to the electrolysis module for conversion of the electric energy E into chemical energy C.

In addition to the treatment of the exhaust gases 11 by the exhaust gas treatment system 12 to form water, carbon monoxide (CO) and carbon dioxide (CO₂) from the exhaust gases can also alternatively be optionally supplied to a reactor module 14, in which the carbon monoxide or respectively the carbon dioxide reacts in a methanation reaction with the hydrogen obtained by splitting water in the electrolysis module 4 to form methane (CH4) and water. The methane obtained during the methanation reaction in the reactor module can also, as previously described for hydrogen, be compressed as chemical energy C via the compressor 6 and supplied to the gas tank 5 of the vehicle or be supplied as anode gas to the fuel cell 10. The water obtained during the methanation reaction can alternatively be provided to the electrolysis module 4 for electrolysis, i.e. to be used for the conversion of the electric energy E into chemical energy. Exhaust gas constituents and substances, which are not treated via the exhaust gas treatment system and are discharged back into the system, are conducted via an exhaust pipe 13 out of the system.

The hydrogen gas, or respectively the methane, introduced into the gas tank 5 via the compressor 6 is provided to the motor 1 in the form of chemical energy C, i.e. burned in the motor 1 as a combustion gas component, or as a reaction gas to the fuel cell 10.

Overall, a better pollutant balance also results from the method 100 according to the invention in addition to the improved energy balance. Said pollutant balance includes a reduction in the CO₂ emissions of the motor because the combustion gas, for example the natural gas or liquefied petroleum gas, can additionally be reduced. The carbon monoxide and particularly the carbon dioxide contained in the exhaust gases 11 can additionally once again be reduced in a reactor module 14 with the hydrogen gas, which was converted in the electrolysis module 4 from electrical energy E into chemical energy, to methane and to water.

In order that the positive energy balance is not negated by the drive of the compressor 6 by using additional electrical energy, said compressor is preferably configured in the form of a turbocharger, which is driven by means of the exhaust gases 11, i.e. with mechanical energy M. The recuperation energy, namely the electric energy E converted from the mechanical energy M by means of the generator 2, can also optionally be used to drive the compressor 6.

As can be seen in the diagram, oxygen obtained from water during the electrolysis can be discharged out of the system; however, it is more energy-efficient, as already described, to either supply the oxygen as combustion gas to the internal combustion engine, i.e. supply it to the motor or supply the oxygen with the hydrogen to the fuel cell 10 in order to obtain electric energy D by forming water, said electric energy can then be provided to the on-board power supply.

In principle, the method 100 depicted as a block diagram in FIG. 1 can be used for vehicles with an internal combustion engine, i.e. preferably for gas operated vehicles which already have a gas tank 5 as well as for vehicles with electric motors, which obtain their energy from a fuel cell 10, and for hybrid vehicles, which namely have an internal combustion engine and at least one electric motor.

1. A method for converting and/or storing electric energy E obtained from mechanical energy M in a vehicle comprising a motor (1), wherein the mechanical energy M is obtained when braking and/or during an overrun operation of the vehicle, the method comprising
a) converting the mechanical energy into electric energy E in a first step using a generator (2),
b) storing the electric energy in an intermediate energy store (3) in a second step,
c) discharging the stored electric energy E to an electrolysis module (4) in a third step,
d) having the module convert the electric energy E into chemical energy C in a fourth step at least by splitting water (H₂O) into hydrogen (H₂) and oxygen (O₂), and
e) conducting the chemical energy into a gas tank (5) of the vehicle for temporary storage and/or supplying the chemical energy to the motor (1) and/or a fuel cell (10) of the vehicle in a fifth step.

2. The method (100) according to claim 1, characterized in that the hydrogen (H₂) is compressed by a compressor (6) prior to temporary storage in the gas tank (5).

3. The method (100) according to claim 1, characterized in that the voltage of an on-board power supply (15) of the vehicle is increased in order to increase the power density of the intermediate energy store (3) for the electric energy E.

4. The method (100) according to claim 1, characterized in that the hydrogen (H₂) reacts with the carbon dioxide (CO₂) present in the exhaust gases and/or carbon monoxide (CO) in a reactor module (14) to form methane (CH₄) and water (H₂O), wherein the methane (CH₄) is conducted into the gas tank (5) of the vehicle and/or supplied to the motor (1).

5. The method (100) according to claim 1, characterized in that the water (H₂O) required for the conversion of electric energy E into chemical energy C comes from a water tank (7) and/or a reactor module (14) and/or the fuel cell (10) and/or from exhaust gas (11) of the motor (1).

6. The method (100) according to claim 1, characterized in that the chemical energy C converted in the form of hydrogen (H₂) and oxygen (O₂) from the electric energy E is supplied to the fuel cell (10), which converts the chemical energy C into electric energy D under reaction of the hydrogen (H₂) with oxygen (O₂) to form water (H₂O).

7. The method (100) according to claim 6, characterized in that the water (H₂O) obtained during the reaction of hydrogen (H₂) and oxygen (O₂) is conducted into the water tank (7) and/or discharged to the electrolysis module (4).

8. The method (100) according to claim 1, characterized in that the compressor (6) is driven electrically and/or via exhaust gases (11) of the motor (1).

9. A mobile system for converting mechanical energy M via electric energy E into chemical energy C, which system is connected to a motor system and/or a fuel cell system of a vehicle, said mobile system comprising a water tank (7), an electrolysis module (4) which is at least connected to the water tank (7) and to which electric energy E is supplied from an intermediate energy store (3) of the motor system and/or of the fuel cell system, and a compressor (6), which is at least connected to a gas tank (5) of the motor system and/or the fuel cell system in order to compress at least the hydrogen (H₂) converted in the electrolysis module (4) from the water (H₂O) prior to being introduced into the gas tank (5).

10. A mobile system for converting electric energy E obtained from mechanical energy M into chemical energy C while carrying out the method of claim 1, the mobile system being is connected to a motor system and/or a fuel cell system of a motor vehicle, said mobile system comprising a water tank (7), an electrolysis module (4) which is at least connected to the water tank (7) and to which electric energy E is supplied from an intermediate energy store (3) of the motor system and/or of the fuel cell system, and a compressor (6), which is at least connected to a gas tank (5) of the motor system and/or the fuel cell system in order to compress at least the hydrogen (H₂) converted in the electrolysis module (4) from the water (H₂O) prior to being introduced into the gas tank (5).

11. The method (100) according to claim 4, characterized in that the water (H₂O) required for the conversion of electric energy E into chemical energy C comes from a water tank (7) and/or the reactor module (14) and/or the fuel cell (10) and/or from exhaust gas (11) of the motor (1).

12. A method (100) for converting and/or storing electric energy E obtained from mechanical energy M in a vehicle comprising a motor (1), wherein the mechanical energy M is obtained when braking and/or during an overrun operation of the vehicle, the method comprising
a) converting the mechanical energy into electric energy E in a first step using a generator (2),
b) storing the electric energy in an intermediate energy store (3) in a second step,
c) discharging the stored electric energy E to an electrolysis module (4) in a third step,
d) having the module convert the electric energy E into chemical energy C in a fourth step at least by splitting water (H₂O) into hydrogen (H₂) and oxygen (O₂), and
e) conducting the chemical energy into a gas tank (5) of the vehicle for temporary storage in a fifth step.

13. A method (100) for converting and/or storing electric energy E obtained from mechanical energy M in a vehicle comprising a motor (1), wherein the mechanical energy M is obtained when braking and/or during an overrun operation of the vehicle, the method comprising
a) converting the mechanical energy into electric energy E in a first step using a generator (2),
b) storing the electric energy in an intermediate energy store (3) in a second step,
c) discharging the stored electric energy E to an electrolysis module (4) in a third step,
d) having the module convert the electric energy E into chemical energy C in a fourth step at least by splitting water (H₂O) into hydrogen (H₂) and oxygen (O₂), and
e) supplying the chemical energy to the motor (1) and/or a fuel cell (10) of the vehicle in a fifth step.

14. The method according to claim 13 wherein the fifth step (e) also includes conducting the chemical energy into a gas tank (5) of the vehicle for temporary storage.
